(19) United States
(12) Patent Application Publication
(10) Pub. No.: US 2014/0210739 A1
(43) Pub. Date: Jul. 31, 2014

(54) OPERATION RECEIVER

(71) Applicant: FUJITSU TEN LIMITED, Kobe-shi (JP)

(72) Inventors: Tetsuaki AONO, Kobe-shi (JP); Takashi OHTA, Kobe-shi (JP); Takaho OKADA, Kobe-shi (JP); Yoshihiro SHIMANO, Kobe-shi (JP)

(73) Assignee: FUJITSU TEN LIMITED, Kobe-shi (JP)

(21) Appl. No.: 14/028,823

(22) Filed: Sep. 17, 2013

(30) Foreign Application Priority Data
Jan. 31, 2013 (JP) 2013-016796

(51) Int. Cl. G06F 3/044

(52) U.S. Cl. CPC G06F 3/044
USPC 345/173

(57) ABSTRACT

An operation receiver includes a first detector and a second detector each of which detects an object. A detection range for the first detector and another detection range for the second detector are located next to each other. The first detector detects a state of the object. A controller makes a judgment as to whether the operation by the object has been carried out to the first detector or to the second detector.

### BACKGROUND OF THE INVENTION

1. Field of the Invention

The invention relates to an apparatus that receives user operations.

2. Description of the Background Art

These days a device that displays an image on a display including a touch panel receives operations from a user by various methods. Such an operation receiver includes various functions. For example, at least one of a navigation function and an audio function is included. The user selects the function reflecting his/her intention out of various functions on the operation receiver. In an example, the user selects the function reflecting his/her intention by touching a prescribed location on an operation surface of the touch panel with his/her at least one finger. As a result, the operation receiver displays an image in accordance with the function selected by the user.

There is another technology. A camera shoots an image of a palm of the user approaching the display. The camera is installed on the operation receiver. The camera shoots images continuously. As a result, the operation receiver obtains various kinds of information including the direction and the speed of the moving palm of the user. Then, the operation receiver executes a function based on the information including the direction and the speed of the moving palm of the user. As above, the technology for an operation receiver to execute a function in response to an out-of-contact operation with a display is disclosed.

On some of the operation receivers providing more functions, when a user carries out a contact operation with a touch panel or an out-of-contact operation with a display for execution of a function, the user has to go through more steps for one operation. As a result, the operation receiver requires more complicated procedure.

On the other hand, in some cases, user's intended function is not executed even when a user carries out one of a contact operation and an out-of-contact operation, corresponding to the intended function. In an example, when a user moves his/her at least one finger closer to a touch panel with the intention to execute a function to be executed by a contact operation, the operation receiver receives the out-of-contact operation that is not intended by the user. That is, in some cases, an operation receiver does not execute the function intended by a user.

### SUMMARY OF THE INVENTION

According to one aspect of the invention, an operation receiver includes a first detector and a second detector each of which detects an object, and a controller that makes a judgment as to whether the operation by the object is carried out to the first detector or to the second detector. A first detection range for the first detector and a second detection range for the second detector are located next to each other, and the first detector detects a state of the object. The user can easily use a contact operation or an approach operation depending on his/her intention.

According to another aspect of the invention, an operation receiver having a touch panel includes a detector that detects that a user has approached the touch panel, an obtaining part that obtains a location information of one of a contact location and an approach location depending on whether the user has approached the touch panel with one point or plural points, the contact location being a location of the touch panel contacted by the user, the approach location being a location of the touch panel having been approached by the user prior to or without contacting the touch panel, and a receiver that receives, based on whether the user has approached the touch panel with one point or plural points, either a first contact command or a first approach command, the first contact command corresponding to the contact location, the first approach command corresponding to the approach location. The user can carry out the operation easier with fewer works. Moreover, the user can use the contact operation or the approach operation depending on his/her intention, which surely executes the function intended by the user.

According to another aspect of the invention, an operation receiver having a touch panel includes a detector that detects that a user has approached the touch panel, an obtaining part that obtains an approach location where the user has approached the touch panel, and a receiver that receives either a first function command or a second function command depending on whether the user has approached the touch panel with one point or plural points, the first function command corresponding to a first function out of a plurality of functions, the second function command corresponding to a second function different from the first function. The user can carry out a sensory and out-of-contact operation, which surely executes the function intended by the user. Therefore, the object of the invention is to provide the technology with which a user can execute an intended function easily and surely.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows an appearance of an operation receiver.

FIG. 2 shows a schematic block diagram of the operation receiver.

FIG. 3 shows an approach operation with plural points to a touch panel by a user.

FIG. 4 shows a cross-section view of the operation receiver seen at an A-A cut line toward the direction in which an arrow points.

FIG. 5 describes receipt of the approach operation carried out by the user.

FIG. 6 shows a one-point contact with the touch panel by the user.

FIG. 7 shows a cross-section view of the operation receiver seen at a B-B cut line toward the direction in which an arrow points.

FIG. 8 describes receipt of the contact operation carried out by the user.

FIG. 9 shows processing flow on the operation receiver.

FIG. 10 shows another processing flow on the operation receiver in terms of user's operations.

FIG. 11 shows an appearance of another operation receiver.

FIG. 12 describes switching of a display image on a display.

FIG. 13 describes an approach operation to the touch panel by the user with one point.

FIG. 14 describes a gesture operation to an operation part by the user.

FIG. 15 shows a search image for a destination search function.

### DESCRIPTION OF THE EMBODIMENTS

Hereinafter, some embodiments of the invention are described with reference to attached drawings.

### First Embodiment

### 1-1. Outline

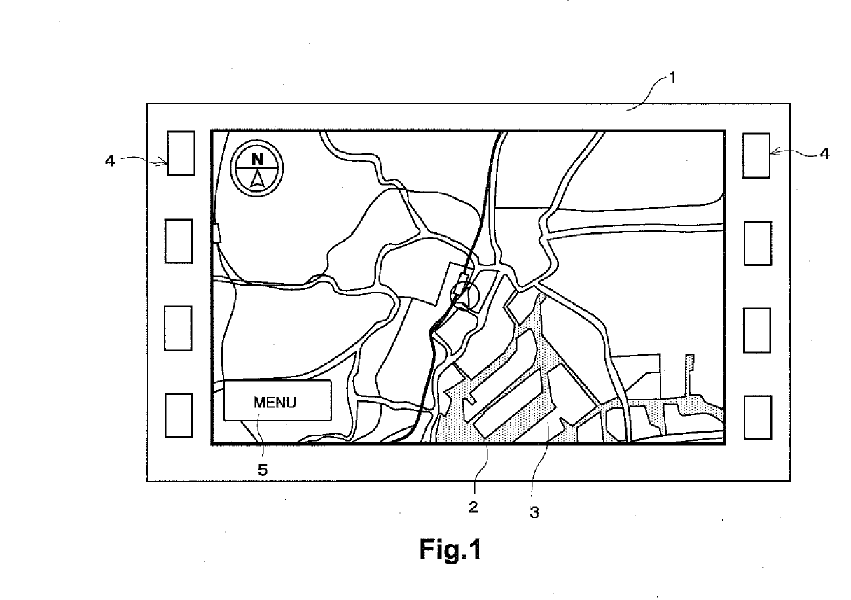

The operation receiver of the invention is outlined. FIG. 1 shows the appearance of an operation receiver 1 of the embodiment. The operation receiver 1 is used, for example, in a vehicle cabin of a car. The operation receiver 1 shows various kinds of information to a user such as a driver in the vehicle cabin by executing the functions included in the operation receiver 1. The operation receiver 1 has, for example, a navigation function for providing route guidance to a destination with a map image displayed on a display. The operation receiver 1 has, for example, an audio function for generating sounds in the vehicle cabin.

Further, the operation receiver 1 has a function for receiving character input. The operation receiver 1 receives the character input at least for one of the operation for destination setting in the navigation function and the operation for title input of audio data in the audio function.

The operation receiver 1 includes a touch panel 3. The operation receiver 1 executes various functions in accordance with the operations carried out by the user on the touch panel 3. The touch panel 3 receives at least one of an out-of-contact operation and a contact operation. For example, the out-of-contact operation that the user carried out with the touch panel 3 changes the capacitance on the operation surface of the touch panel 3. The operation receiver 1 derives the information on the location where the user has carried out the operation on the operation surface of the touch panel 3, based on the changed value of capacitance (hereinafter, referred to as “capacitance value”). The capacitance value varies depending on the number of the user's fingers used. The operation receiver 1 judges whether the user has used one finger or plural fingers for the operation, based on the capacitance value.

### 1-2. Configuration

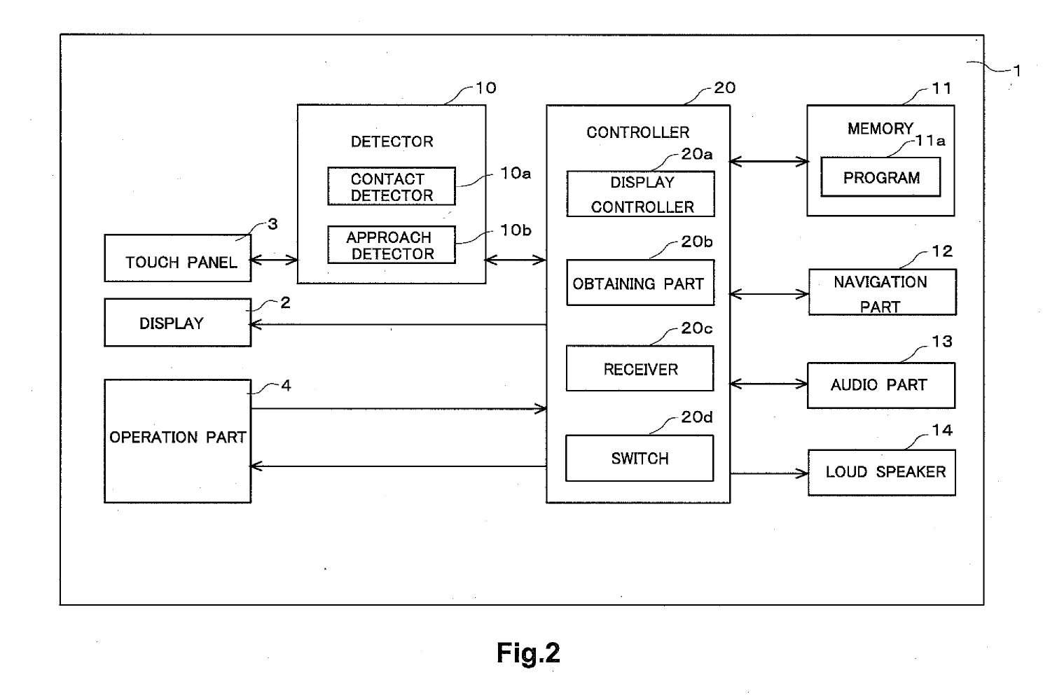

Next, the configuration of the operation receiver 1 is described. FIG. 2 shows a schematic block diagram of the operation receiver 1. The operation receiver 1 includes, as shown in FIG. 2, a display 2, the touch panel 3, an operation part 4, a detector 10, a memory 11, a navigation part 12, an audio part 13, a loud speaker 14 and a controller 20.

The display 2 is composed of, for example, a glass board. The display 2 displays various kinds of information. The touch panel 3 is used when the user carries out the out-of-contact operation or the contact operation on the operation receiver 1. The touch panel 3 has on the operation surface a plurality of electrodes, such as transparent electrodes, not shown in the figure. Each of the plurality of electrodes of the touch panel 3 is connected electrically to, for example, one of a plurality of sensors. Each of the plurality of sensors detects the capacitance value at each of the electrodes.

The operation surface of the touch panel 3 is arranged over the display surface of the display 2. Each location on the operation surface of the touch panel 3 corresponds to one of the locations on the display surface of the display 2. The operation surface of the touch panel 3 is arranged closer to the user than the surface of the display 2. The surface of the touch panel 3 is covered by a protective cover or another material. Hereinafter, the operation surface of the touch panel 3 may be referred to as “touch panel 3.” Further hereinafter, the display surface of the display 2 is referred to as “display 2.”

The display 2 displays icons such as a command button 5. In response to user's operation to touch with his/her at least one finger the location on the touch panel 3 that corresponds to the area of the command button 5, the operation receiver 1 receives the command that corresponds to the area of the command button 5 touched by the user. Upon the receipt of the command, the operation receiver 1 executes the processing that corresponds to the command. As above, the function reflecting user's intention is executed.

Hereinafter, the operation where the user touches the touch panel 3 with his/her at least one finger is referred to as a contact operation. In response to the user's contact operation, the operation receiver 1 detects the contact location based on the capacitance value generated on the touch panel 3, and receives the command that corresponds to the location of the contact operation by the user.

There is another operation, an approach operation, which is different from the contact operation described above. The approach operation is the operation where the user moves his/her at least one finger closer to the touch panel 3. In response to the user's at least one finger moving closer to the touch panel 3 without an actual contact, the capacitance of the touch panel 3 changes. Then, the operation receiver 1 detects the approach of the user and its location based on the capacitance value.

Upon the detection of the location of the touch panel 3 approached by the user with his/her at least one finger prior to or without contacting the touch panel, the operation receiver 1 receives the command that corresponds to the location of the approach operation by the user. In other words, the operation receiver 1 receives the command that corresponds to the approach location by the user.

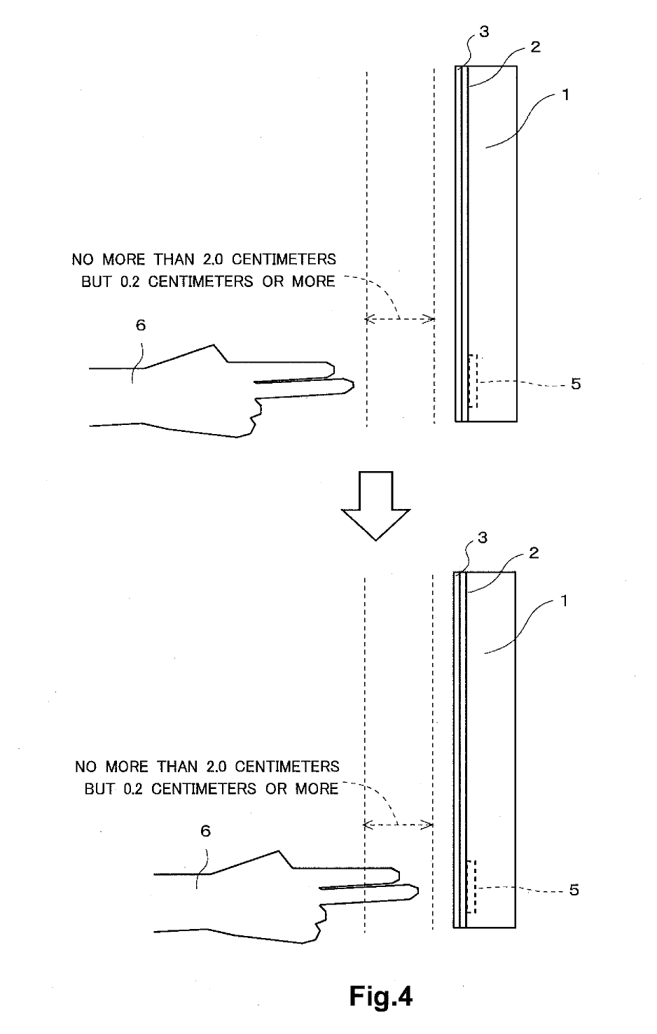

Upon the receipt of the command according to one of the contact operation and the approach operation, the operation receiver 1 executes the processing that corresponds to the command. That is, the operation receiver 1 executes the function reflecting the user's intention. The situation where the user has approached the touch panel 3 with his/her at least one finger is described as follows. For example, as shown in FIG. 4 described later, the distance between the user's fingertips and the touch panel 3 is in the range of 0.2 centimeters or more but no more than 2.0 centimeters.

The operation part 4 is a physical switch for operation by the user. The operation part 4 is, for example, a hardware button. A plurality of the operation parts 4 are installed in the periphery of the display 2. In response to the pressure by the user with his/her at least one finger on specific one of the operation parts 4, the operation receiver 1 receives the command corresponding to the location of the operation part 4 on which the user has carried out the contact operation. In other words, the operation receiver 1 receives the command that corresponds to the location touched by the user.

The detector 10 is the sensor that is connected to the electrode disposed on the touch panel 3 and that detects the capacitance value of the electrode. The detector 10 is composed of, for example, a hardware circuit. The detector 10 has a plurality of functions including a contact detector 10a and an approach detector 10b.

The contact detector 10a has a function for detecting the capacitance value generated when the user touches the touch panel 3 with his/her at least one finger.

In particular, the contact detector 10a has the function for detecting the capacitance value when the user touches the touch panel 3 with his/her at least one finger based on a mutual capacitance method. In the mutual capacitance method, the capacitance value between two electrodes of a driving electrode and a receiving electrode is measured. When the user touches the touch panel 3 with his/her at least one finger, the contact detector 10a detects the capacitance value as follows. The contact of the user's finger with the touch panel 3 blocks the electric field of the touch panel 3, which reduces the charge received at the receiving electrode. The contact detector 10a detects the capacitance value changed when the user touches the touch panel 3 with his/her at least one forger.

The approach detector 10b has the function for detecting the capacitance value based on a self-capacitance method when user's at least one finger has approached the touch panel 3. In response to the approach of the user's at least one finger to the electrode, the capacitance changes depending on the stray capacitance generated between the user's at least one finger and the electrode. In the self-capacitance method, the approach detector 10b detects the capacitance value changed depending on the stray capacitance. The capacitance value changes depending on the number of the fingers, one or plurality, having approached the touch panel 3. Thus, the capacitance value when one finger of the user has approached the touch panel 3 is different from the capacitance value when plural fingers have approached the touch panel 3.

As above, the approach detector 10b detects the approach to the touch panel 3 of the user's at least one finger. Moreover, the approach detector 10b detects whether one finger of the user has approached the touch panel 3 or plural fingers have approached the touch panel 3. In this case, the plural fingers are, for example, the two fingers next to each other of one hand of the user.

The fact where the approach detector 10b detects the approach to the touch panel 3 of the user's at least one finger, and detects whether one finger of the user has approached the touch panel 3 or plural fingers have approached the touch panel 3 may be described as follows, in other words. The approach detector 10b detects the object existing in the space that corresponds to a detection range for capacitance value detection. In addition to the user's at least one finger, one part of user's body including his/her palm, for example, may be detected as the object. As well, a pencil-shape operation member may be detected as the object.

The capacitance value is detected by one of the functions, the contact detector 10a or the approach detector 10b. The function is switched between the contact detector 10a and the approach detector 10b in accordance with prescribed conditions. A switch 20d switches the function between the contact detector 10a and the approach detector 10b. That is, the switching by the switch 20d corresponds to the switching of the detection method between the mutual capacitance method and the self-capacitance method. The method for switching the function by the switch 20d is detailed later.

The memory 11 is a nonvolatile memory, such as a flash memory, which is able to store various kinds of data. The memory 11 stores various kinds of data and a program 11a for processing on the operation receiver 1.

The navigation part 12 executes the navigation function for providing route guidance to a destination, using the map data stored in the memory 11. The audio part 13 executes the audio function for generating sounds via the loud speaker 14, using the audio data stored in the memory 11.

The controller 20 controls the whole of the operation receiver 1. The controller 20 is, for example, a microcomputer that includes a CPU, RAM and ROM. The controller 20 executes various functions using the program 11a stored in the memory 11. The program 11a is read out from a memory medium such as a memory card, and is stored in the memory 11 in advance. In the case where the operation receiver 1 includes a communication function via a network, the program 11a may be obtained through the communication between the operation receiver 1 and another communication device.

The controller 20 primarily includes a display controller 20a, an obtaining part 20b, a receiver 20c and the switch 20d. These are a part of the functions executed by the controller 20 by use of the program 11a.

The display controller 20a controls the display of images or others on the display 2. The display controller 20a controls, for example, the display of a map image. The display controller 20a controls the display of a command button (for example, the command button 5) on the display 2. The command button 5 is the object for one of the contact operation and the approach operation.

The obtaining part 20b obtains the capacitance value detected by the contact detector 10a. The obtaining part 20b obtains based on the capacitance value the information on the location touched by the user on the touch panel 3. The information on the location is the information on one particular point of the touch panel 3.

The obtaining part 20b obtains the capacitance value detected by the approach detector 10b. The obtaining part 20b obtains based on the capacitance value the information on the location of the touch panel 3 approached by the user's at least one finger, and the information on the number of the user's fingers having approached the touch panel 3. The information on the location is the information on one particular point of the touch panel 3.

The user's fingertip has a small area. Thus, in a certain area of the touch panel 3, the capacitance value changes according to the approach to the touch panel 3 of user's at least one finger. In the case where the user moves his/her one finger (one point) closer to the touch panel 3, the area where the capacitance value changes is smaller than the area in the case where the user moves his/her plural fingers (plural points) closer to the touch panel 3. That is, as for the detection area in which the approach detector 10b detects the capacitance value, the size of the detection area in the case where the user has approached the touch panel 3 with one point is different from the size of the detection area in the case where the user has approached the touch panel 3 with plural points. As a result, the capacitance value detected when the user has approached the touch panel 3 with plural points is bigger than the capacitance value detected when the user has approached the touch panel 3 with one point.

The receiver 20c receives the command that corresponds to the location of the touch panel 3 touched or approached by the user's at least one finger. The receiver 20c receives from the obtaining part 20b the information on the location of the touch panel 3 touched by the user's at least one finger, and receives the command that corresponds to the location of the touch panel 3 where the user has carried out the contact operation. In an example, when the user touches the display area of the command button 5 with his/her at least one finger, the receiver 20c receives from the obtaining part 20b the information on the location of the contact. The receiver 20c receives the command that corresponds to the location of the touch panel 3 where the user has carried out the contact operation.

When the user touches the operation part 4 with his/her at least one finger, the receiver 20c receives from the obtaining part 20b the information on the location of its contact, and receives the command that corresponds to the location of the operation part 4 where the user has carried out the contact operation.

The receiver 20c receives from the obtaining part 20b the information on the location of the touch panel 3 approached by the user's at least one finger, and receives the command that corresponds to the location of the touch panel 3 where the user has carried out the approach operation. In an example, when the user moves his/her at least one finger close to the display area of the command button 5, the receiver 20c receives from the obtaining part 20b the information on the approach location prior to or without contacting the command button 5. The receiver 20c receives the command that corresponds to the location of the touch panel 3 where the user has carried out the approach operation.

When the user moves his/her at least one finger close to the operation part 4, the receiver 20c receives from the obtaining part 20b the information on the approach location prior to or without contacting the operation part 4, and receives the command that corresponds to the location of the operation part 4 where the user has carried out the approach operation.

The switch 20d switches between the detection by the contact detector 10a and the detection by the approach detector 10b in accordance with the prescribed conditions. Examples of the prescribed conditions are as follows. When one finger of the user approaches the touch panel 3 to the location where the distance to the touch panel 3 is less than the prescribed distance (for example, less than 0.2 centimeters), the switch 20d switches the detection method from the detection by the approach detector 10b to the detection by the contact detector 10a. After the switching, the contact detector 10a detects the capacitance value. When one finger of the user gets farther from the touch panel 3 than the prescribed distance (for example, 0.2 centimeters or more), the switch 20d switches the detection method from the detection by the contact detector 10a to the detection by the approach detector 10b. After the switching, the approach detector 10b detects the capacitance value.

In the case where the switch 20d switches the detection method from the detection by the contact detector 10a to the detection by the approach detector 10b, the approach detector 10b detects the capacitance value after a prescribed period of time (for example, three seconds) since the switching. In other words, unless a prescribed period of time has passed since the switching of the detection method from the detection by the contact detector 10a to the detection by the approach detector 10b, the approach detector 10b does not detect the capacitance value. This prevents the execution of the function on the operation receiver 1 based on an unintended approach operation by the user.

### 1-3. Input Operation by User

Next, the approach operation and the contact operation by the user are concretely described.

### 1-3-1. Plural-Points Approach Operation

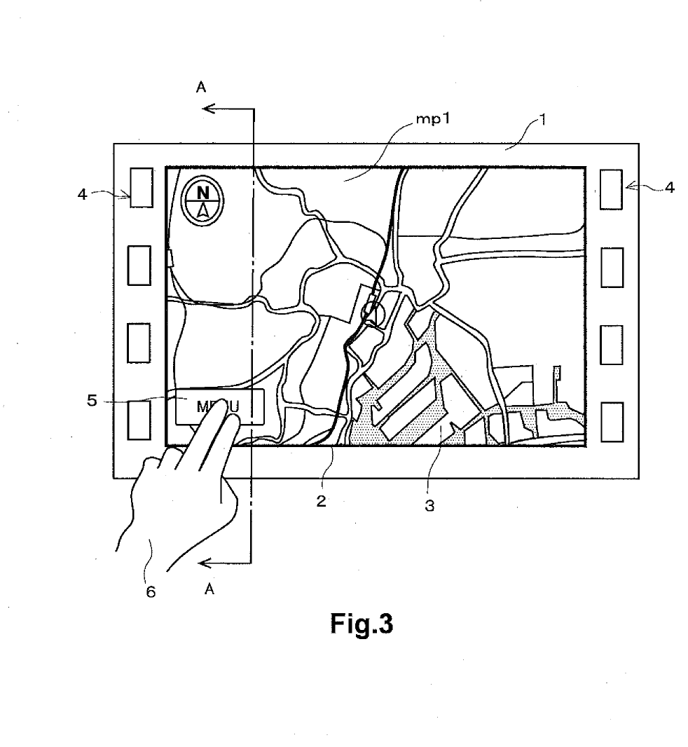

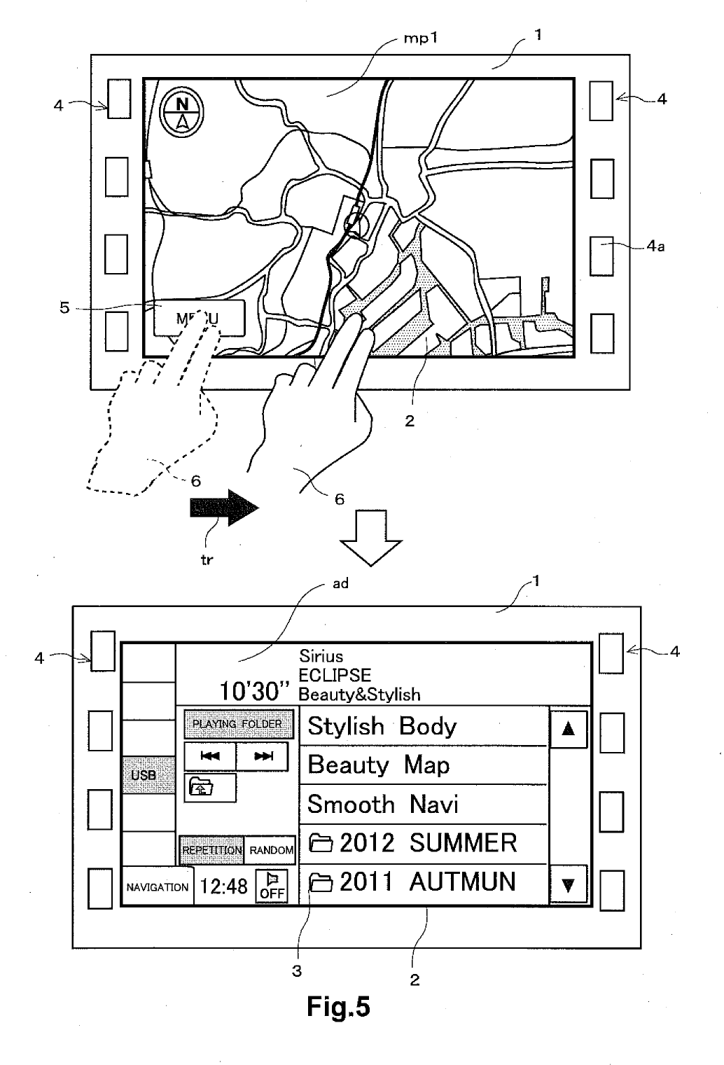

The approach operation with the plural points by the user 6 is described in reference to FIG. 3, FIG. 4 and FIG. 5. FIG. 3 shows the approach operation with the plural points to the touch panel 3 by a user 6. In FIG. 3, the operation receiver 1 displays a map image mp1 on the display 2 through the execution of the navigation function. The display 2 displays the command button 5 that is superimposed on the map image mp1.

In the case where the user 6 moves his/her two fingers close to the touch panel 3 that laps over the display 2, the approach detector 10b detects the capacitance value in response to the approach to the touch panel 3 with the plural points by the user 6. Next, such a case is described in reference to FIG. 4 that shows the cross section of the operation receiver 1 of FIG. 3.

FIG. 4 shows the cross section view of the operation receiver 1 that is seen at an A-A cut line toward the direction in which an arrow points. The upper figure of FIG. 4 shows that the plural fingers of the user 6 are far from the range in proximity to the touch panel 3. In other words, the plural fingers of the user 6 are at the location outside the prescribed distance range from the touch panel 3 (over 2.0 centimeters).

The lower figure of FIG. 4 shows that the plural fingers of the user 6 have moved from the location outside the prescribed distance range to the location inside the prescribed distance range. Such movement of the plural fingers of the user 6 to the location inside the prescribed distance range changes the capacitance generated between the plural fingertips of the user 6 and the electrode disposed on the touch panel 3. That is, the shorter the distance between the plural fingertips of the user 6 and the electrode becomes, the bigger the capacitance becomes. The approach detector 10b detects the capacitance value in response to the increase of the capacitance. While the approach detector 10b is detecting the capacitance value, the contact detector 10a does not detect the capacitance value.

The obtaining part 20b obtains from the approach detector 10b the first approach location information that is the information on the location approached by the user 6 with the plural points. Then, the obtaining part 20b transmits the first approach location information to the receiver 20c. The first approach location information is the information on the location of one particular point on the touch panel 3, and shows that the user 6 has approached the touch panel 3 with the plural points. The receiver 20c receives the first approach location information from the obtaining part 20b, and receives the command that corresponds to the location where the user 6 has carried out the approach operation. In an example, the receiver 20c receives the command that corresponds to the approach location corresponding to the command button 5.

As above, the capacitance generated between the fingertips of the user 6 and the electrode disposed on the touch panel 3 increases with increasing number of the fingers of the user 6. That is, the larger the total area of the fingertips of the user 6 becomes, the bigger the capacitance becomes.

Next, the receipt of the approach operation carried out by the user 6 is concretely described. FIG. 5 describes the receipt of the approach operation carried out by the user 6. As shown in the upper figure of FIG. 5, the user 6 moves his/her plural fingers from the location where the plural fingers are in proximity to the touch panel 3 (for example, the area of the command button 5) to the direction shown by an arrow tr (for example, rightward). That is, the user 6 moves his/her plural fingers from one location to another substantially-parallel to the surface of the touch panel 3, while keeping the fingers in proximity to the touch panel 3. As above, in response to such movement of the plural fingers of the user 6 from one point to another of the touch panel 3, the receiver 20c receives the command that corresponds to the location of the command button 5 where the user 6 has carried out the approach operation.

When the receiver 20c receives the command in response to the operation where the user 6 moves his/her plural fingers from one point to another substantially-parallel to the surface of the touch panel 3 while keeping the fingers in proximity to the touch panel 3 (hereinafter, referred to as “gesture operation”), the operation receiver 1 executes the function corresponding to the received command. In an example, when the receiver 20c receives the command corresponding to the execution of the audio function, the display controller 20a switches the display on the display 2 from the map image mp1 shown in the upper figure of FIG. 5 to an audio image ad shown in the lower figure of FIG. 5.

Hereinafter, the operation where the user 6 moves his/her one finger from one point to another substantially-parallel to the surface of the touch panel 3 while keeping the finger in proximity to the touch panel 3 may be referred to as a gesture operation.

### 1-3-2. One-Point Contact Operation

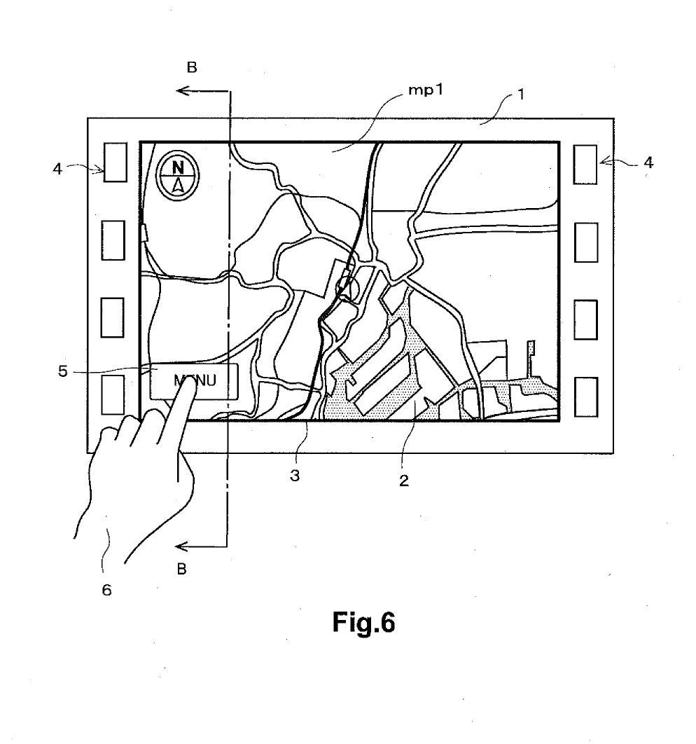

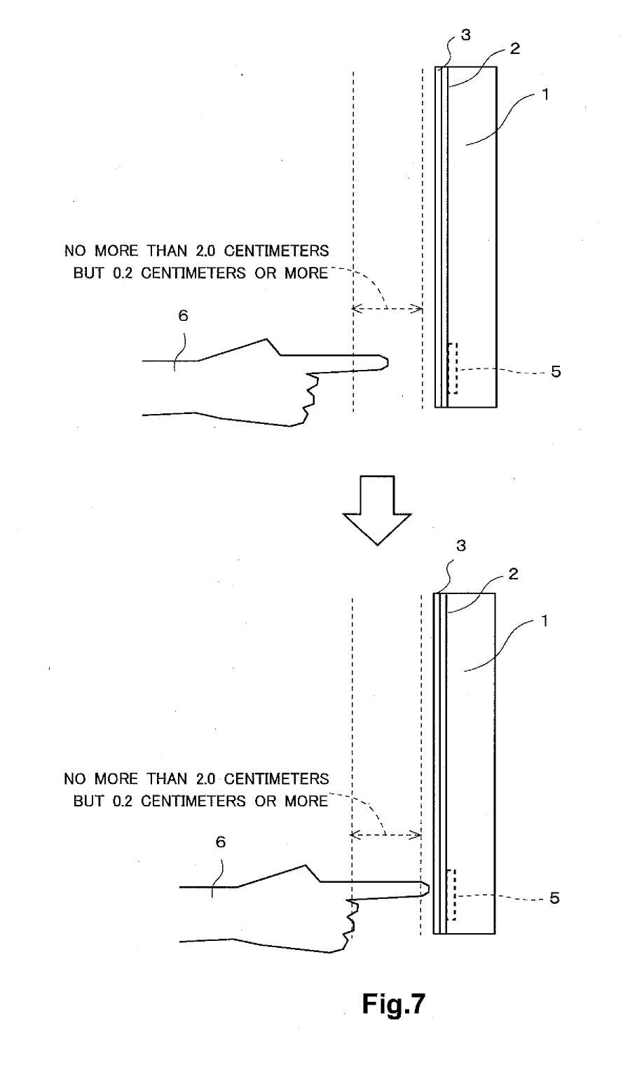

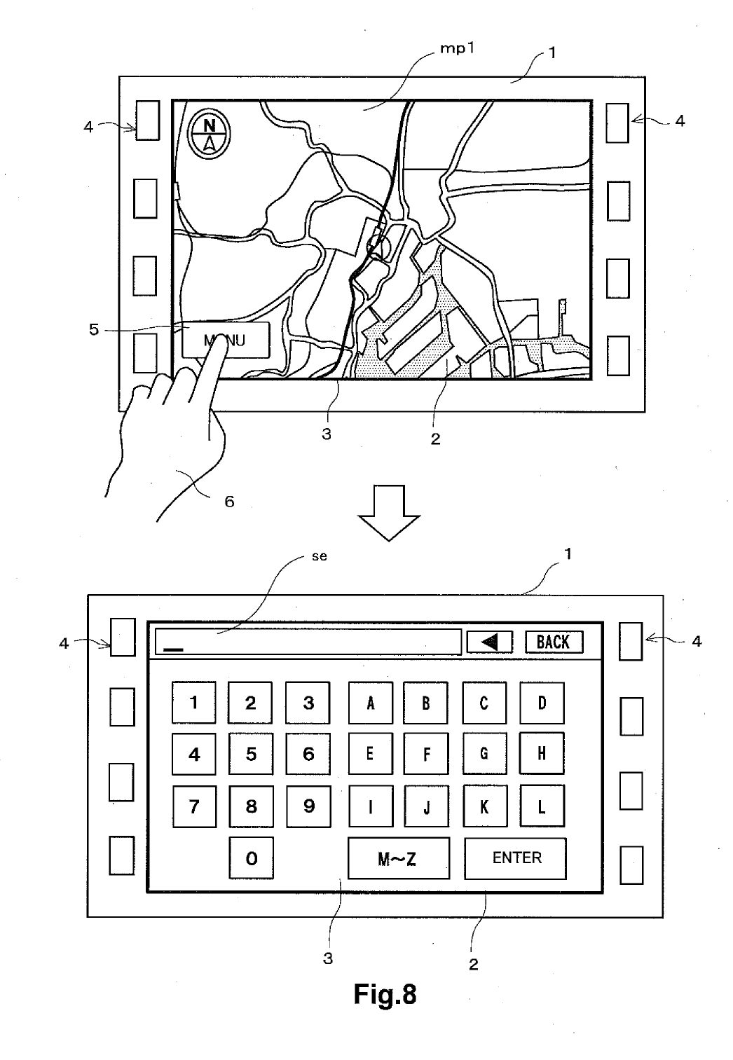

Next, a one-point contact operation by the user 6 is described in reference to FIG. 6, FIG. 7 and FIG. 8. FIG. 6 shows the one-point contact with the touch panel by the user 6. In FIG. 6, like in FIG. 3, the operation receiver 1 displays the map image mp1 on the display 2 in response to the execution of the navigation function. The display 2 displays the command button 5 that is superimposed on the map image mp1. In response to the contact of one finger with the touch panel 3 by the user 6, the contact detector 10a detects the capacitance value generated due to the one-point contact with the touch panel 3 by the user 6. Next, such an operation is described in reference to FIG. 7 that shows the cross section of the operation receiver 1 of FIG. 6.

FIG. 7 shows the cross section view of the operation receiver 1 that is seen at a B-B cut line toward the direction in which an arrow points. The upper figure of FIG. 7 shows that one finger of the user 6 is in proximity to the touch panel 3. In other words, one finger of the user 6 is at the location inside the prescribed distance range (0.2 centimeters or more but no more than 2.0 centimeters) from the touch panel 3.

In response to the approach to the touch panel 3 of one finger of the user 6 while detecting the capacitance value, the approach detector 10b detects the capacitance value that has changed according to the approach with one point by the user 6.

The obtaining part 20b obtains from the approach detector 10b the second approach location information that is the information on the location approached by the user 6 with one point. Then, the obtaining part 20b transmits the second approach location information to the receiver 20c. The second approach location information is the information on the location of one particular point on the touch panel 3, and shows the location where the user 6 has approached the touch panel 3 with one point prior to or without contacting the touch panel 3. The receiver 20c receives the second approach location information from the obtaining part 20b, and receives the command that corresponds to the location where the user 6 has carried out the approach operation.

Next, the lower figure of FIG. 7 shows that one finger of the user 6 has moved from the location inside the prescribed distance range to the location much closer to the touch panel 3 (the location in proximity less than 0.2 centimeters). Such movement of the one finger of the user 6 to the location much closer to the touch panel 3 changes the capacitance generated between one fingertip of the user 6 and the electrode disposed on the touch panel 3. That is, the shorter the distance between the one fingertip of the user 6 and the electrode becomes, the bigger the capacitance becomes.

In response to the movement of the one finger of the user 6 to the location much closer to the touch panel 3, the switch 20d switches the detection method from the detection by the approach detector 10b to the detection by the contact detector 10a. As a result, the contact detector 10a detects the capacitance value, while the approach detector 10b does not detect the capacitance value.

The one finger of the user 6 moves much closer to the touch panel 3 from the location in proximity, and then touches the touch panel 3. As a result, the contact detector 10a detects the capacitance value in response to the touch of the one finger of the user 6 to the touch panel 3.

The obtaining part 20b obtains from the contact detector 10a the contact location information that is the information on the location contacted by the user 6 with one point. Then, the obtaining part 20b transmits the contact location information to the receiver 20c. The contact location information is the information on the location of one particular point on the touch panel 3, and shows the location where the user 6 has contacted the touch panel 3 with one point. The receiver 20c receives the contact location information from the obtaining part 20b, and receives the command that corresponds to the location where the user 6 has carried out the contact operation.

Next, the receipt of the contact operation carried out by the user 6 is described. FIG. 8 describes the receipt of the contact operation carried out by the user 6. As shown in the upper figure of FIG. 8, the user 6 uses his/her one finger in contact with the touch panel 3 (for example, the area of the command button 5) for the contact operation. In response to this operation, the receiver 20c receives the command that corresponds to the location of the command button 5 where the user 6 has carried out the contact operation. When the receiver 20c receives the command of the command button 5, the operation receiver 1 executes the function that corresponds to the command of the command button 5. In an example, when the command of the command button 5 corresponds to the execution of the function for destination search, the display controller 20a switches the display image on the display 2 from the map image mp1 shown in the upper figure of FIG. 8 to a search image se shown in the lower figure of FIG. 8.

In FIG. 5, the audio function is described as an example of the function to be executed in response to the approach operation carried out by the user 6. In FIG. 8, the function for destination search is described as an example of the function to be executed in response to the contact operation carried out by the user 6. As above, the operation even at the same location on the touch panel 3 but by a different operation method by the user 6 may provide the execution of a different function.

In other words, depending on which detector, the contact detector 10a or the approach detector 10b, detects the capacitance value, a different command is received when the operation has been carried out even at the same location on the touch panel 3 but by a different operation method. As a result, the operation receiver 1 executes the function in accordance with the operation method. This allows the user 6 to carry out the operations easier with fewer works. Moreover, the operation reflecting the intention of the user 6 is judged accurately, and thus the function reflecting the intention of the user 6 is surely executed. In other words, the user 6 can use the contact operation or the approach operation of the out-of-contact operation depending on his/her intention, and the function reflecting the intention of the user 6 is surely executed.

The situation, described above, where the switch 20d switches the method for detecting the capacitance value from the detection by the approach detector 10b to the detection by the contact detector 10a, is seen in the following case. It is when the one finger of the user 6 is at the location that is closer to the touch panel 3 than any location inside the prescribed distance range is to the touch panel 3. Contrarily, when the plural fingers of the user 6 are at the location that is closer to the touch panel 3 than any location inside the prescribed distance range is to the touch panel 3, the switch 20d does not switch the method for detecting the capacitance value. As a result, the contact detector 10a does not detect the capacitance value. In other words, even in the case where the plural fingers of the user 6 are at the location that is closer to the touch panel 3 than any location inside the prescribed distance range is to the touch panel 3, the approach detector 10b keeps detecting the capacitance value. As described so far, in the side of the operation surface of the touch panel 3, the detection range that has a prescribed distance range where the capacitance value is detected (hereinafter, referred to as “prescribed detection range”) is provided. There exists the following relation between the operation surface of the touch panel 3 and the prescribed detection range. The prescribed detection range is, as shown in FIG. 4 and FIG. 7, in the proximity to the operation surface of the touch panel 3. In other words, the prescribed detection range is adjacent to the operation surface of the touch panel 3. The first detection range of the approach detector 10b and the second detection rang of the contact detector 10a are configured such that when the first detection range is located to face the user 6, the first detection range is located closer to the user 6 than is the second detection rang. This allows the user 6 easily to use the contact operation or the approach operation depending on his/her intention.

There also exists the following relation between the touch panel 3 and the prescribed detection range. In the case where the operation surface of the touch panel 3 faces the user 6, the prescribed detection range is provided closer to the user 6 than the operation surface of the touch panel 3. This allows the user 6 to carry out the operations easily.

### 1-4. Processing Flow

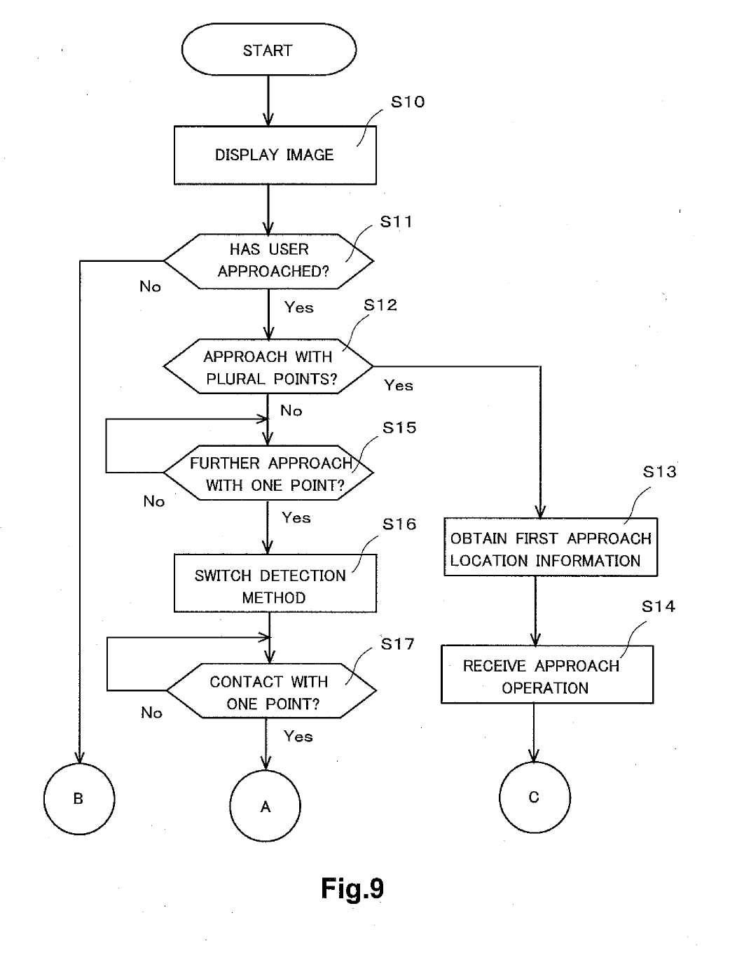

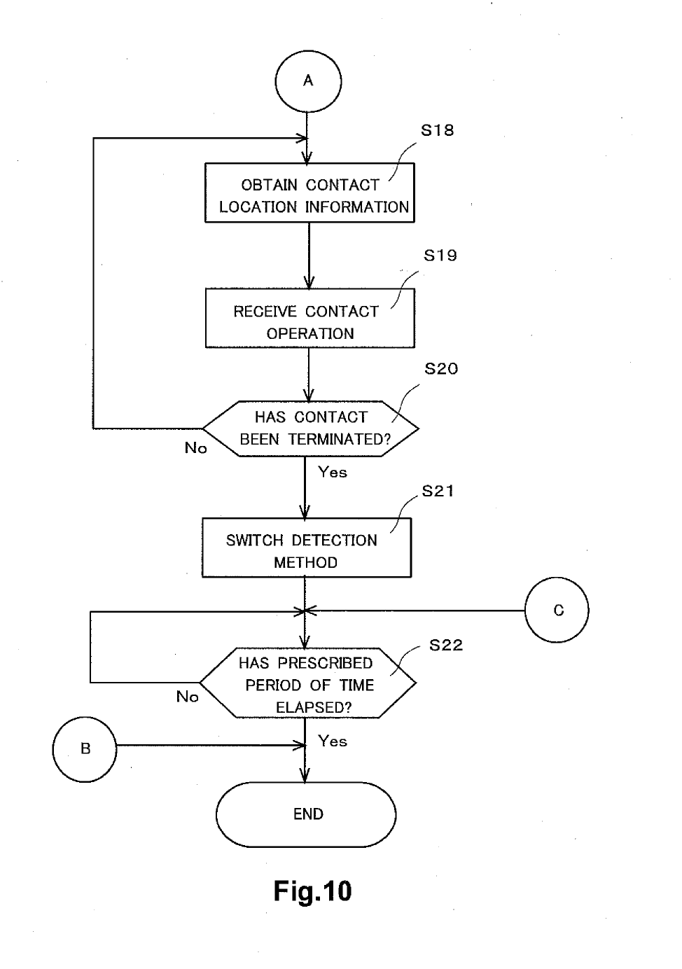

Each of FIG. 9 and FIG. 10 shows the processing flow on the operation receiver 1. Hereafter, the processing flow on the operation receiver 1 is described with reference to FIG. 9 and FIG. 10.

The display 2 displays an image (for example, the map image mp1) based on the control by the display controller 20a (step S10). The approach detector 10b detects the capacitance value generated between the fingertip of the user 6 and the electrode of the touch panel 3. The obtaining part 20b judges whether at least one finger of the user 6 has approached the touch panel 3 based on the capacitance value (step S11).

When judging that the user 6 has approached the touch panel 3 based on the capacitance value exceeding the first prescribed value (Yes at the step S11), the obtaining part 20b judges based on the capacitance value whether the approach by the user 6 is with the plural points (step S12). The first prescribed value is the threshold value for judging whether at least one finger of the user 6 has approached the touch panel 3.

When judging that the user 6 has approached the touch panel 3 with his/her plural fingers, based on the capacitance value exceeding the second prescribed value (Yes at the step S12), the obtaining part 20b obtains the first approach location information (step S13). The second prescribed value is the threshold value for judging whether the approach to the touch panel 3 by the user 6 is with one point or plural points.

The receiver 20c receives the first approach location information from the obtaining part 20b, and receives the command that corresponds to the location where the user 6 has carried out the approach operation (step S14). As a result, the operation receiver 1 executes the function that corresponds to the command. The operation receiver 1 executes the audio function, for example.

When a prescribed period of time (for example, approx. two seconds) has passed since the execution of the function (Yes at the step S22 shown in FIG. 10), the operation receiver 1 terminates the processing in response to the approach operation. After the termination of the processing, another processing is repeated. The reason why the operation receiver 1 terminates the processing after the prescribed period of time is as follows. It is because the operation receiver 1 starts another processing when at least one finger of the user 6 has moved outside the prescribed detection range after the reception of one approach operation carried out by the user 6. In other words, the approach operation by an object is prohibited for a prescribed period of time. This prevents the reception of an unintended operation by the user 6, and thus prevents the execution of an unintended function by the user 6.

For a prescribed period of time after the execution of the function in response to the approach operation (No at the step S22), the step S22 is repeated.

As for the description back to the step S11 in FIG. 9, when the obtaining part 20b judges that the capacitance value detected by the approach detector 10b is below the first prescribed value (No at the step S11), the operation receiver 1 terminates the processing. The case where the capacitance value is below the first prescribed value as above is seen when none of the fingers of the user 6 is in proximity to the touch panel 3.

Back at the step S12, when judging that the capacitance value is below the second prescribed value (No at the step S12), the obtaining part 20b judges whether the capacitance value above the first prescribed value has increased further as time advances. The obtaining part 20b judges whether the user 6 has approached the touch panel 3 with one point based on the judgment as to whether the capacitance value has increased further (step S15). In other words, the obtaining part 20b judges whether the one finger of the user 6 is closer to the touch panel 3 than any location inside the prescribed distance range is to the touch panel 3.

When the obtaining part 20b judges that the user 6 has further approached the touch panel 3 with one point (Yes at the step S15), the switch 20d switches the method for detecting the capacitance value (step S16). The switch 20d switches the detection method from the detection by the approach detector 10b to the detection by the contact detector 10a.

When the obtaining part 20b judges that the user 6 has not approached further the touch panel 3 with one point (No at the step S15), the step S15 is kept repeated. After the step S15 has been kept repeated for a certain period of time, the operation receiver 1 terminates the repeating flow and executes the first step (the step S10).

When judging that the user 6 is in contact with the touch panel 3 with one point (Yes at the step S17), the obtaining part 20b obtains the contact location information (step S18).

The receiver 20c receives the contact location information from the obtaining part 20b, and receives the command that corresponds to the location where the user 6 has carried out the contact operation (step S19). As a result, the operation receiver 1 executes the function that corresponds to the received command.

Then, the obtaining part 20b judges whether one-point contact to the touch panel 4 by the user 6 has been terminated (step S20). The obtaining part 20b judges whether the one-point contact to the touch panel 3 by the user 6 has been terminated, based on the capacitance value in response to the detachment of the finger of the user 6 from the contact location on the touch panel 3.

When the obtaining part 20b judges that the one-point contact to the touch panel 3 by the user 6 has been terminated (Yes at the step S20), the switch 20d switches the method for detecting the capacitance value. The switch 20d switches the detection method from the detection by the contact detector 10a to the detection by the approach detector 10 (step S21). After the switching of the detection method, when the prescribed period of time has elapsed since the execution of the function (Yes at the step S22), the operation receiver 1 starts receiving the approach operation. In other words, on the operation receiver 1, the reception of any operation by an object is prohibited for a period of time after the switching to the detection of the approach operation till when at least one finger of the user 6 moves outside the prescribed detection range. Based on the judgment as to whether the operation by the object has been carried out to the first detector or to the second detector, the operation receiver 1 prohibits the operation by the object for a prescribed period of time in relation to the other one of the approach detector 10b and the contact detector 10a. This prevents the reception of an unintended operation by the user 6, and thus prevents the execution of an unintended function by the user 6.

At the step S20, when the obtaining part 20b judges that the one-point contact to the touch panel 3 by the user 6 has not been terminated yet (No at the step S20), the operation receiver 1 returns to the step S18 for execution. When the flow of the step S18, the step S19 and the step S20 has been repeated for a certain period of time, the operation receiver 1 terminates the repeating flow and executes the first step (step S10).

At the step S22, when judging that the prescribed period of time has not elapsed (No at the step S22), the judgment as to whether the prescribed period of time has passed is repeated. Further, when the step S22 has been repeated for a certain period of time, the operation receiver 1 terminates the repeating flow and executes the first step (step S10).

The processing described in reference to the flowcharts shown in FIG. 9 and FIG. 10 allows the user 6 appropriately to use the contact operation or the approach operation depending on his/her intention on the operation receiver 1 that provides plural functions. This also allows the user 6 to carry out the operation easier with fewer works. Moreover, the intended operation by the user 6 is judged accurately, and thus the intended function by the user 6 is surely executed. The user 6 can appropriately use the contact operation or the approach operation of the out-of-contact operation with the touch panel 3 depending on his/her intention.

### Second Embodiment

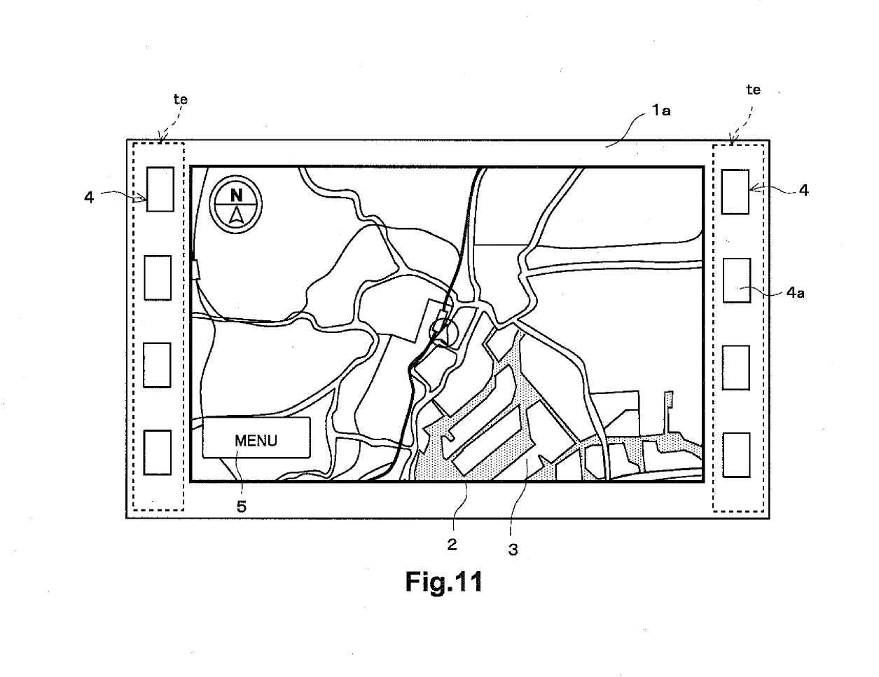

Next, the second embodiment is described. The configuration and the processing on an operation receiver of the second embodiment are substantially the same as the ones of the first embodiment, but are partially different. On the operation receiver 1 of the first embodiment, the plurality of electrodes are disposed on the touch panel 3. The approach detector 10b of the first embodiment detects the capacitance value in response to the approach to the touch panel 3 by the user 6. On an operation receiver 1a, shown in FIG. 11, of the second embodiment to be described, a plurality of electrodes are disposed in the area for an operation part 4 and the peripheral area of the operation part 4. An approach detector 10b of the second embodiment detects the capacitance value in response to the approach to the operation part 4 by a user 6. Hereafter, the points different from the first embodiment are primarily described.

FIG. 11 shows the appearance of the operation receiver 1a. An operation area to that includes the area for the operation part 4 of the operation receiver 1a and the periphery area of the operation part 4 has the plurality of electrodes not shown in the figure.

The approach detector 10b detects the capacitance value showing that one finger of the user 6 is closer to the operation part 4 than any location inside the prescribed distance range is to the operation part 4. As a result, a switch 20d switches the detection method based on the capacitance value. That is, the switch 20d switches the detection method from the detection by the approach detector 10b to the detection by a contact detector 10a.

The location inside the prescribed distance range is in the distance range of 0.2 centimeters or more but no more than 2.0 centimeters from the operation part 4. The location closer to the operation part 4 than any location inside the prescribed distance range is less than 0.2 centimeters away from the operation part 4.

When obtaining the information on the location where one point of the user 6 is in contact with the operation part 4, an obtaining part 20b transmits the location information to a receiver 20c. The receiver 20c receives the location information from the obtaining part 20b, and receives the command that corresponds to the location where the user 6 has carried out the contact operation. In other words, the receiver 20c receives the command that corresponds to the location of the contact by the user 6.

When the user 6 has approached the operation part 4 with plural points, the approach detector 10b detects the capacitance value in response to the approach to the operation part 4 with plural points by the user 6. When obtaining the information on the location where the user 6 has approached the operation part 4 with the plural points based on the capacitance value, the obtaining part 20b transmits the location information to the receiver 20c.

The receiver 20c receives the location information from the obtaining part 20b, and receives the command that corresponds to the location where the user 6 has carried out the approach operation. In other words, the receiver 20c receives the command that corresponds to the location where the user 6 is in proximity. This allows the user 6 to carry out the operation easily with fewer works. This also allows the user 6 to use the contact operation or the approach operation of the out-of-contact operation depending on his/her intention, which surely executes the intended function by the user 6.

### Third Embodiment

In the third embodiment, an operation receiver 1 executes a different function depending on whether a user 6 has approached a touch panel 3 with one point or plural points. The configuration and the processing on the operation receiver 1 of the third embodiment are substantially the same as the ones of the first embodiment, but are partially different. Hereafter, the different points are primarily described.

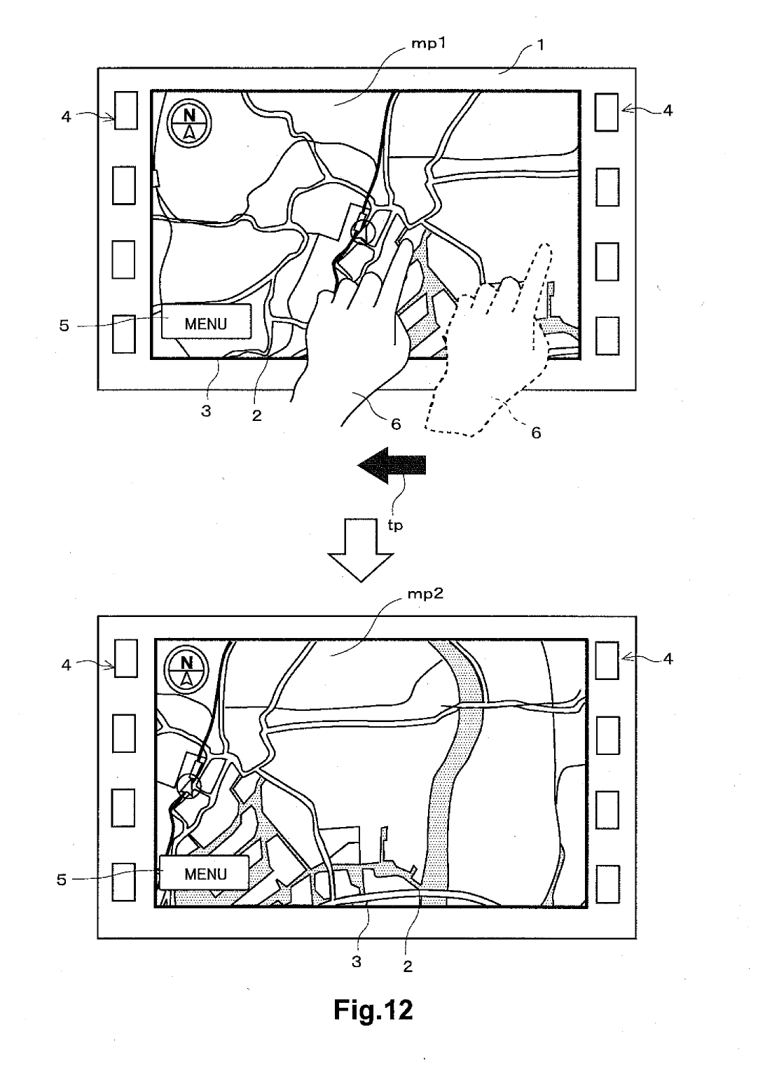

FIG. 12 describes the switching of the display image on a display 2. The operation receiver 1 switches the display image on the display 2 within the same function in response to the approach to the touch panel 3 with one point by the user 6. One concrete example of the execution of a navigation function on the operation receiver 1 is described.

In the upper figure of FIG. 12, the operation receiver 1 displays a map image mp1 on the display 2 in response to the execution of the navigation function. The user 6 moves his/her one finger from the location that is in proximity to the touch panel 3 toward the direction shown by an arrow tp (for example, leftward). That is, the user 6 carries out a gesture operation to move his/her one finger from one location to another substantially-parallel to the surface of the touch panel 3, while keeping the finger in proximity to the touch panel 3. The location of the touch panel 3 approached by the user 6 is, for example, the location that corresponds to one point in a prescribed area on the map image mp1 shown in the upper figure of FIG. 12.

As above, when the user 6 carries out the approach operation with one point, the operation receiver 1 executes in the same function the command that corresponds to the location where the user 6 has carried out the approach operation, while keeping executing the same function as before the approach operation. In particular, as shown in the upper figure and the lower figure of FIG. 12, the gesture operation by the user 6 makes scrolling the map image mp1 displayed on the display 2 to display on the display 2 a map image mp2 that shows another area.

On the other hand, when the user 6 carries out the approach operation with plural points, the operation receiver 1 executes the command in the function different from the one executed before the approach operation. For description, the operation receiver 1 shown in FIG. 5 of the first embodiment is taken as an example. On the operation receiver 1 that is providing the navigation function as shown in FIG. 5, the gesture operation by the user 6 with plural points executes the audio function. In other words, the operation receiver 1 executes the function different from the navigation function in response to the gesture operation with plural points by the user 6.

As above, the operation receiver 1 receives one of the first function command and the second function command depending on whether the user 6 approaches the touch panel 3 with one point or plural points. This allows the user 6 to carry out a sensory and out-of-contact operation, which surely executes the function intended by the user 6. The first function command is the command relevant to the function that has been executed on the operation receiver 1 before the approach operation to the touch panel 3 with one point by the user 6. The second function command is the command relevant to the function different from the one that has been executed on the operation receiver 1 before the approach operation to the touch panel 3 with plural points by the user 6.

### Fourth Embodiment

In the fourth embodiment, an operation receiver 1 executes the command corresponding to one of the approach operation to a touch panel 3 and the approach operation to an operation part 4, depending on whether a user 6 approaches the touch panel 3 with one point or plural points. The configuration and the processing of the operation receiver 1 of the fourth embodiment are substantially the same as the ones of the first embodiment, but are partially different. Hereafter, the different points are primarily described.

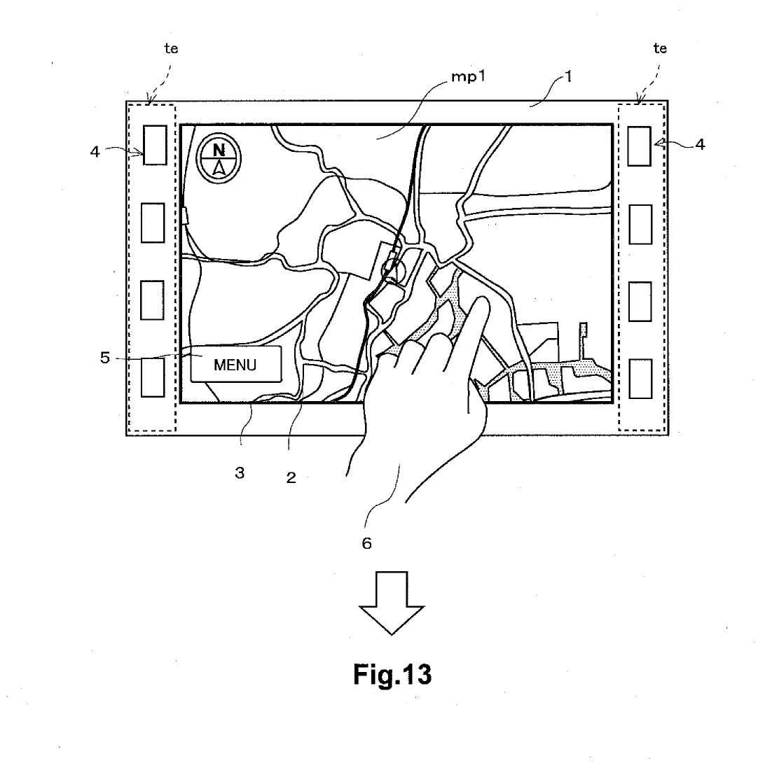

FIG. 13 describes the approach operation to the touch panel 3 by the user 6 with one point. A display 2 in FIG. 13 displays a map image mp1 in response to the execution of a navigation function on the operation receiver 1. The user 6 is in proximity to the touch panel 3 with one point. An approach detector 10b detects the capacitance value corresponding to the approach to the touch panel 3 by the user 6 with one point.

An obtaining part 20b judges that the approach to the touch panel 3 by the user 6 has been made with one point, based on the capacitance value. As a result, a receiver 20c receives the approach operation to the operation part 4 by the user 6. In other words, the receiver 20c does not receive the approach operation to the touch panel 3 by the user 6.

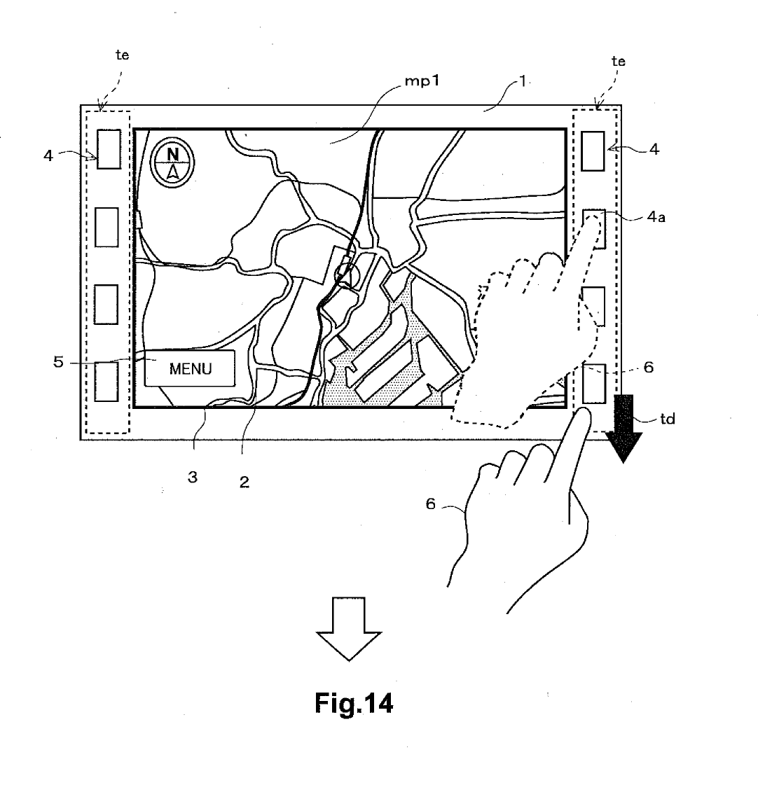

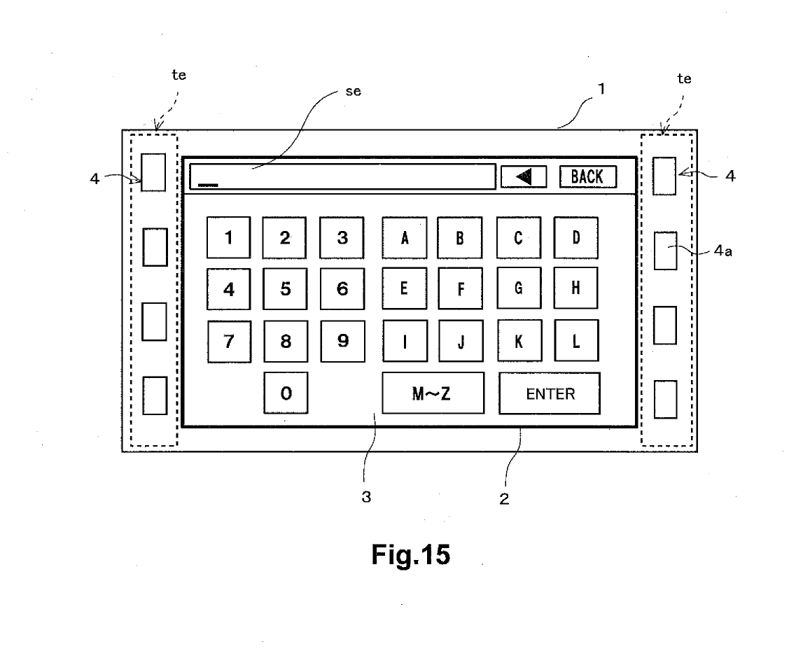

The receiver 20c receives the location information of the operation part 4 from the obtaining part 20b, and receives the command that corresponds to the location where the user 6 has carried out the approach operation. FIG. 14 describes the gesture operation to the operation part 4 by the user 6. In an example, the user 6 moves, as shown in FIG. 14, his/her one finger from the approach location in proximity to a hardware button 4a toward the direction shown by an arrow td (for example, downward). That is, the user 6 carries out the gesture operation to move his/her one finger from one location to another substantially-parallel to the surface of the hardware button 4a, while keeping the finger in proximity to the hardware button 4a. As a result, the receiver 20c receives the command that corresponds to the hardware button 4a. FIG. 15 shows a search image for a destination search function. In the case where the function that corresponds to the hardware button 4a is the destination search function, a display controller 20a displays a search image se for the destination search function shown in FIG. 15. This allows the user 6 to use one of the operations that correspond to the functions on the operation receiver 1 depending on his/her intention.

When an approach detector 10b detects the capacitance value corresponding to the approach to the touch panel 3 by the user 6 with the plural points, the obtaining part 20b judges that the approach to the touch panel 3 by the user 6 has been made with plural points, based on the capacitance value. As a result, the receiver 20c receives the approach operation to the touch panel 3 by the user 6. In other words, the receiver 20c does not receive the approach operation to the operation part 4 by the user 6.

<Modification>

The embodiments of the invention have been described so far. However, the invention is not to be considered limited to the first, the second, the third and the fourth embodiments described above, and may provide various modifications. Hereafter, these modifications are described. All embodiments including from the first embodiment to the fourth embodiment described above and the embodiments to be described below can be arbitrarily combined with others.

In the embodiments from the first embodiment to the fourth embodiment, the location of the touch panel 3 approached by the user 6 with no contact is detected by the self-capacitance method. However, the location may be detected by other methods such as an infrared method.

Different from the embodiments from the first embodiment to the fourth embodiment, the approach to and the contact with a touch panel 3 with one point and plural points by a user may be detected based on a mutual capacitance method.

Further, different from the embodiments from the first embodiment to the fourth embodiment, the approach operation to a touch panel 3 by a user 6 may be made with three or more fingers in a row on one hand of the user 6 or with two or more fingers of two hands of the user 6.

Further, different from the embodiments from the first embodiment to the fourth embodiment, a receiver 20c may receive the following operation. When plural fingers of a user 6 have been in proximity to a touch panel 3 for more than a prescribed period of time (for example, two seconds or more), the receiver 20c may receive the command that corresponds to the location where the user 6 is in proximity to the touch panel 3. Moreover, as long as the command that corresponds to the location where a user 6 has carried out an approach operation is acceptable, the receiver 20c may receive the command in response to other operations by the user 6.

In the description above of the embodiments from the first embodiment to the fourth embodiment, the user 6 uses at least one of the objects including the fingers of the user 6, the palm of the user 6 and a stylus for operation on the operation receiver 1. In other words, the operation receiver 1 carries out the functions based on the state of the object. The state of the object is the location of the object and others, for example, the number and the approach location of the fingers of the user 6 to the touch panel 3.

Further, in the description above of the embodiments from the first embodiment to the fourth embodiment, the device for use in a vehicle cabin of a vehicle is taken as an example of the operation receiver 1. However, the operation receiver 1 may be another electronic device, such as a smartphone or a tablet device, as long as the device accepts character input by use of a touch panel.

Further, in the description above of the embodiments from the first embodiment to the fourth embodiment, the contact detector 10a detects the capacitance value in response to the contact with the touch panel 3 or other parts by the user 6 with his/her at least one finger, and then the obtaining part 20b obtains the capacitance value. Different from the processing above, a contact detector 10a may detect the capacitance value at the time when a user 6 moves his/her at least one finger to the location where the distance to a touch panel 3 or other parts is less than a prescribed distance, and then an obtaining part 20b may obtain the capacitance value. The distance less than the prescribed distance is, for example, less than 0.2 centimeters. That is, the situation is that the fingertip of the user 6 is substantially in contact with the surface of the touch panel 3 or other parts. As a result, the obtaining part 20b obtains the information on the location of the touch panel 3 based on the capacitance value detected by the contact detector 10a, even when the user 6 carries out the operation other than a direct contact with the touch panel 3 or other parts. Then, a receiver 20c receives the command based on the location information.

Further, in the description above of the embodiments from the first embodiment to the fourth embodiment, the operation receiver that displays an image on the display 2 is taken as an example. However, the operation receiver may output information other than images to a user 6.

Further, in the description above of the embodiments from the first embodiment to the fourth embodiment, various functions are executed by software, specifically by CPU processing based on programs. However, some of these functions may be executed by electrical hardware circuits. Contrarily, some of the functions executed by hardware circuits in the above description may be executed by software.

Different from the first embodiment and the second embodiment, an operation receiver 1 may execute the command that corresponds to the location where a user 6 carries out an approach operation when the user 6 approaches one of a touch panel 3 and an operation part 4 with one point. The operation receiver 1 may also execute the command that corresponds to the location where the user 6 carries out a contact operation when the user 6 touches one of the touch panel 3 and the operation part 4 with plural points.

Further, in the description of the fourth embodiment, depending on whether the user 6 approaches a touch panel 3 with one point or plural points, one of the approach operation to the touch panel 3 and the approach operation to an operation part 4 may be received. Contrarily, depending on whether a user 6 approaches an operation part 4 with one point or plural points, one of the approach operation to a touch panel 3 and the approach operation to the operation part 4 may be received.

While the invention has been shown and described in detail, the foregoing description is in all aspects illustrative and not restrictive. It is therefore understood that numerous other modifications and variations can be devised without departing from the scope of the invention.

What is claimed is:

1. An operation receiver that receives an operation of a user, the operation receiver comprising:
a first detector and a second detector each of which detects an object; and
a controller that makes a judgment as to whether the operation by the object has been carried out to the first detector or to the second detector, wherein
a first detection range for the first detector and a second detection range for the second detector are located next to each other, and
the first detector detects a state of the object.

2. The operation receiver of claim 1, wherein
the first detector detects the object that has approached an operation surface of a touch panel,
the second detector detects the object in contact with the operation surface of the touch panel, and
the state of the object is whether the object is one finger or a plurality of fingers.

3. The operation receiver of claim 1, wherein
the first and second detectors are configured such that when the first detection range is located to face the user, the first detection range is located closer to the user than is the second detection range.

4. The operation receiver of one of claim 2, wherein
the first and second detectors are configured such that when the first detection range is located to face the user, the first detection range is located closer to the user than is the second detection range.

5. The operation receiver of claim 1, wherein
based on the judgment as to whether the operation by the object has been carried out to the first detector or to the second detector, the controller prohibits the operation by the object for a prescribed period of time in relation to the other one of the first detector and the second detector.

6. The operation receiver of claim 2, wherein
based on the judgment as to whether the operation by the object has been carried out to the first detector or to the second detector, the controller prohibits the operation by the object for a prescribed period of time in relation to the other one of the first detector and the second detector.

7. The operation receiver of claim 3, wherein
based on the judgment as to whether the operation by the object has been carried out to the first detector or to the second detector, the controller prohibits the operation by the object for a prescribed period of time in relation to the other one of the first detector and the second detector.

8. The operation receiver of claim 4, wherein
based on the judgment as to whether the operation by the object has been carried out to the first detector or to the second detector, the controller prohibits the operation by the object for a prescribed period of time in relation to the other one of the first detector and the second detector.

9. An operation receiver that includes a touch panel, the operation receiver comprising:
a detector that detects that a user has approached the touch panel;
an obtaining part that obtains a location information of one of a contact location and an approach location depending on whether the user has approached the touch panel with one point or plural points, the contact location being a location of the touch panel contacted by the user, the approach location being a location of the touch panel having been approached by the user prior to or without contacting the touch panel; and
a receiver that receives, based on whether the user has approached the touch panel with one point or plural points, either a first contact command or a first approach command, the first contact command corresponding to the contact location, the first approach command corresponding to the approach location.

10. The operation receiver of claim 9, wherein
the receiver (i) receives the first contact command when the user has approached the touch panel with one point, and (ii) receives the first approach command when the user has approached the touch panel with plural points.

11. The operation receiver of claim 9, further comprising:
an operation part that is disposed at a periphery of the touch panel, wherein
the detector detects that the user has approached the operation part,
the obtaining part obtains one of the contact location and the approach location depending on whether the user has approached the operation part with one point or plural points, the contact location being a location of the operation part contacted by the user, the approach location being a location of the operation part having been approached by the user prior to or without contacting the operation part, and
the receiver receives either a second contact command or a second approach command depending on whether the user has approached the touch panel or the operation part with one point or plural points, the second contact command corresponding to the contact location on the operation part, the second approach command corresponding to the approach location on the operation part.

12. The operation receiver of claim 10, further comprising:
an operation part that is disposed at a periphery of the touch panel, wherein
the detector detects that the user has approached the operation part,
the obtaining part obtains one of the contact location and the approach location depending on whether the user has approached the operation part with one point or plural points, the contact location being a location of the operation part contacted by the user, the approach location being a location of the operation part having been approached by the user prior to or without contacting the operation part, and
the receiver receives either a second contact command or a second approach command depending on whether the user has approached the touch panel or the operation part with one point or plural points, the second contact command corresponding to the contact location on the operation part, the second approach command corresponding to the approach location on the operation part.

13. The operation receiver of claim 11, wherein
the receiver receives the second contact command when the user has approached either the touch panel or the operation part with one point, and receives the second approach command when the user has approached either the touch panel or the operation part with plural points.

14. The operation receiver of claim 12, wherein
the receiver receives the second contact command when the user has approached either the touch panel or the operation part with one point, and receives the second approach command when the user has approached either the touch panel or the operation part with plural points.

15. An operation receiver that includes a touch panel, the operation receiver comprising:
a detector that detects that a user has approached the touch panel;
an obtaining part that obtains an approach location where the user has approached the touch panel; and
a receiver that receives either a first function command or a second function command depending on whether the user has approached the touch panel with one point or plural points, the first function command corresponding to a first function out of a plurality of functions, the second function command corresponding to a second function different from the first function.
